(19) United States
(12) Patent Application Publication
(10) Pub. No.: US 2016/0065605 A1
(43) Pub. Date: Mar. 3, 2016

(54) SPAM DETECTION FOR ONLINE SLIDE DECK PRESENTATIONS

(71) Applicant: LinkedIn Corporation, Mountain View, CA (US)

(72) Inventors: Baoshi Yan, Belmont, CA (US); Jiaqi Guo, Milpitas, CA (US); Haishan Liu, Sunnyvale, CA (US); Mohammad Shafkat Amin, Cupertino, CA (US)

(21) Appl. No.: 14/547,948

(22) Filed: Nov. 19, 2014

Related U.S. Application Data
(60) Provisional application No. 62/044,109, filed on Aug. 29, 2014.

(51) Int. Cl. H04L 29/06; G06N 99/00; G06F 3/0484

(52) U.S. Cl. CPC H04L 63/1425; G06F 3/04847; G06N 99/005

(57) ABSTRACT

The disclosed systems and methods are directed to detecting spam in an electronic presentation and determining whether the electronic presentation should be moderated. The example systems and methods may employ one or more classifiers for classifying an electronic presentation and, should the electronic presentation fall within a predetermined classification, the electronic presentation may be analyzed further for the presence of spam. Further analysis of the electronic presentation may include invoking one or more filters to determine whether the electronic presentation includes words and/or phrases known to be associated with spam. Where the electronic presentation is determined to contain spam, the electronic presentation may be removed from a database of electronic presentations, excluded from search results, or flagged for moderation by a moderator.

### CROSS-REFERENCE TO RELATED APPLICATIONS

This application claims the benefit of priority to U.S. Pat. App. No. 62/044,109, filed Aug. 29, 2014 and titled “SPAM DETECTION FOR ONLINE SLIDE DECK PRESENTATIONS,” the disclosure of which is incorporated by reference herein.

### TECHNICAL FIELD

The subject matter disclosed herein generally relates to a system and method for detecting spam in online slide deck presentations and, in particular, determining whether an online slide deck presentation is likely to be spam based on its contents.

### BACKGROUND

An electronic presentation (e.g., a slide deck) may include information that a user finds interesting. For example, an electronic presentation may include audiovisual and/or textual content that engages the user. The electronic presentation may be available from a repository of other electronic presentations. For example, a user may visit a website where electronic presentations are made available to the user. Using a graphical user interface, the user may select and view an electronic presentation made available through the graphical user interface.

However, as the electronic presentations may be provided by other users of the website, a malicious user may decide to leverage an electronic presentation as a vehicle for spam, such as unsolicited job offers, marketing schemes, false promises of wealth or fortune, unrealistic claims for dietary supplements, and other such spam. For the malicious user, an electronic presentation may be an ideal vehicle for spam since the malicious user can bury the spam within one or more slides of the electronic presentation and the unwary viewer of the electronic presentation does not encounter the spam until the viewer has started viewing of the electronic presentation. Furthermore, the presence of spam in the electronic presentations dissuades users from using the website, which leads to a loss of prestige, viewer traffic, and credibility as a platform for sharing electronic presentations.

### BRIEF DESCRIPTION OF THE DRAWINGS

Some embodiments are illustrated by way of example and not limitation in the figures of the accompanying drawings.

FIG. 1 is a block diagram of a system, in accordance with an example embodiment, for determining whether electronic presentations contain spam.

FIG. 2 is a block diagram illustrating an arrangement, in accordance with an example embodiment, of the electronic presentation server and the social networking server configured to exchange messages.

FIG. 3 illustrates the electronic presentation server shown in FIG. 1 in accordance with an example embodiment.

FIG. 4 illustrates the social networking server shown in FIG. 1 in accordance with an example embodiment.

FIG. 5 illustrates an example method, according to an example embodiment, for classifying and applying a filter to individual slides of an electronic presentation.

FIG. 6 illustrates a graphical user interface, in accordance with an example embodiment, displaying an electronic presentation hosted by the electronic presentation server.

FIG. 7 illustrates a method, according to an example embodiment, for determining whether an electronic presentation contains spam.

FIGS. 8A-8C illustrate another method, according to an example embodiment, for determining whether an electronic presentation contains spam.

FIG. 9 is a block diagram illustrating components of a machine, in accordance with an example embodiment, configured to read instructions from a machine-readable medium.

### DETAILED DESCRIPTION

Example methods and systems are directed to detecting spam in an electronic presentation and determining whether the electronic presentation should be moderated. The example methods and systems may employ one or more classifiers for classifying an electronic presentation and, should the electronic presentation fall within a predetermined classification, the electronic presentation may be analyzed further for the presence of spam. Further analysis of the electronic presentation may include invoking one or more filters to determine whether the electronic presentation includes words and/or phrases known to be associated with spam. In one embodiment, the electronic presentation is classified as a whole. In another embodiment, each slide of the electronic presentation is classified, and a determination is made whether to moderate the electronic presentation in accordance with a number or percentage of slides in which spam was detected. The example methods and systems involve various technologies, such as natural language processing, feature extraction, machine-learning, and binary classification. Moreover, the disclosed systems and methods have the technical effect of reducing the time in which it takes in identifying which electronic presentations from a set of electronic presentations contain spam and in deciding how to treat those electronic presentations which may contain spam.

Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one embodiment, this disclosure provides a computer-implemented method that includes receiving an electronic presentation, the electronic presentation comprising a plurality of slides, wherein at least one slide contains content for viewing by a user, extracting content from a slide selected from the plurality slides based on a determination that the selected slide contains content, determining a plurality of features for each slide of the plurality of slides based on the content extracted from a corresponding slide, assigning a classification to each slide based on the features determined for the corresponding slide, the assigned classification identifying the type of content contained within the corresponding slide, applying a filter to each slide based on the features determined for the slide, the applied filter identifying whether the slide contains a predetermined plurality of alphanumeric characters, determining whether each slide of the plurality of slides contains spam based on the applied filter and assigned classification to the slide, adjusting the spam determination of each slide of the plurality of slides based on a location of a corresponding slide relative to the plurality of slides of the electronic presentation, and determining whether the electronic presentation is spam based on the adjusted spam determination for each slide of the plurality of slides.

In another embodiment of the computer-implemented method, assigning the classification to each slide is based on the application of a maximum entropy classifier to each slide.

In a further embodiment of the computer-implemented method, assigning the classification to each slide is based on a classification model trained for the classification.

In yet another embodiment of the computer-implemented method, the method includes selecting the filter from a plurality of filters to apply to each slide based on the classification assigned to the corresponding slide, wherein a first filter of the plurality of filters is associated with a first classification and a second filter of the plurality of filters is associated with a second classification.

In yet a further embodiment of the computer-implemented method, the method includes modifying the electronic presentation based on the adjusted spam determination.

In another embodiment of the computer-implemented method, modifying the electronic presentation comprises removing the electronic presentation from being discoverable by a search query applied to a plurality of electronic presentations.

In a further embodiment of the computer-implemented method, modifying the electronic presentation comprises removing a slide selected from a plurality of slides based on the adjusted spam determination for the selected slide.

In yet another embodiment of the computer-implemented method, the method includes identifying the electronic presentation for moderation based on the adjusted spam determination.

This disclosure also provides for a system that includes a non-transitory, computer-readable medium storing computer-executable instructions, an one or more processors in communication with the non-transitory, computer-readable medium that, having executed the computer-executable instructions, are configured to receive an electronic presentation, the electronic presentation containing a plurality of slides, wherein at least one slide contains content for viewing by a user, for each slide of the plurality of slides, determine a plurality of features for a corresponding slide, the determined features based on content extracted from the corresponding slide, assign at least one classification to each slide of the plurality of slides based on the features determined for the corresponding slide, determine whether a filter is satisfied for each slide of the plurality of slides, the filter identifying whether a given slide includes a plurality of alphanumeric characters, determine a spam value for each slide of the plurality of slides, the spam value based on the assigned classification for the corresponding slide, whether the filter was satisfied for the corresponding slide, and a location of the corresponding slide relative to the plurality of slides, and determine an overall spam value for the electronic presentation, the overall spam value based on each spam value determined for each slide of the plurality of slides.

In another embodiment of the system, one or more processors are further configured to assign the classification to each slide based on the application of a maximum entropy classifier to each slide.

In a further embodiment of the system, the one or more processors are configured to assign the classification to each slide based on a classification model trained for the classification.

In yet another embodiment of the system, the one or more processors are further configured to select the filter from a plurality of filters to apply to each slide based on the classification assigned to the corresponding slide, wherein a first filter of the plurality of filters is associated with a first classification and a second filter of the plurality of filters is associated with a second classification.

In yet a further embodiment of the system, the one or more processors are further configured to modify the electronic presentation based on the overall spam value.

In another embodiment of the system, the one or more processors are configured to modify the electronic presentation by removing the electronic presentation from being discoverable by a search query applied to a plurality of electronic presentations.

In a further embodiment of the system, the one or more processors are configured to modify the electronic presentation by removing a slide selected from a plurality of slides based on the adjusted spam determination for the selected slide

In yet another embodiment of the system, the one or more processors are further configured to identify the electronic presentation for moderation based on the overall spam value.

This disclosure further provides for a non-transitory, computer-readable medium storing computer-executable instructions thereon that, when executed by one or more processors, cause the one or more processors to perform a method, the method including receiving an electronic presentation, the electronic presentation comprising a plurality of slides, wherein at least one slide contains content for viewing by a user, extracting content from a slide selected from the plurality slides based on a determination that the selected slide contains content, determining a plurality of features for each slide of the plurality of slides based on the content extracted from a corresponding slide, assigning a classification to each slide based on the features determined for the corresponding slide, the assigned classification identifying the type of content contained within the corresponding slide, applying a filter to each slide based on the features determined for the slide, the applied filter identifying whether the slide contains a predetermined plurality of alphanumeric characters, determining whether each slide of the plurality of slides contains spam based on the applied filter and assigned classification to the slide, adjusting the spam determination of each slide of the plurality of slides based on a location of a corresponding slide relative to the plurality of slides of the electronic presentation, and determining whether the electronic presentation is spam based on the adjusted spam determination for each slide of the plurality of slides.

In another embodiment of the non-transitory, computer-readable medium, assigning the classification to each slide is based on the application of a maximum entropy classifier to each slide.

In a further embodiment of the non-transitory, computer-readable medium, the method further comprises modifying the electronic presentation based on the adjusted spam determination.

In yet another embodiment of the non-transitory, computer-readable medium, modifying the electronic presentation comprises removing the electronic presentation from being discoverable by a search query applied to a plurality of electronic presentations.

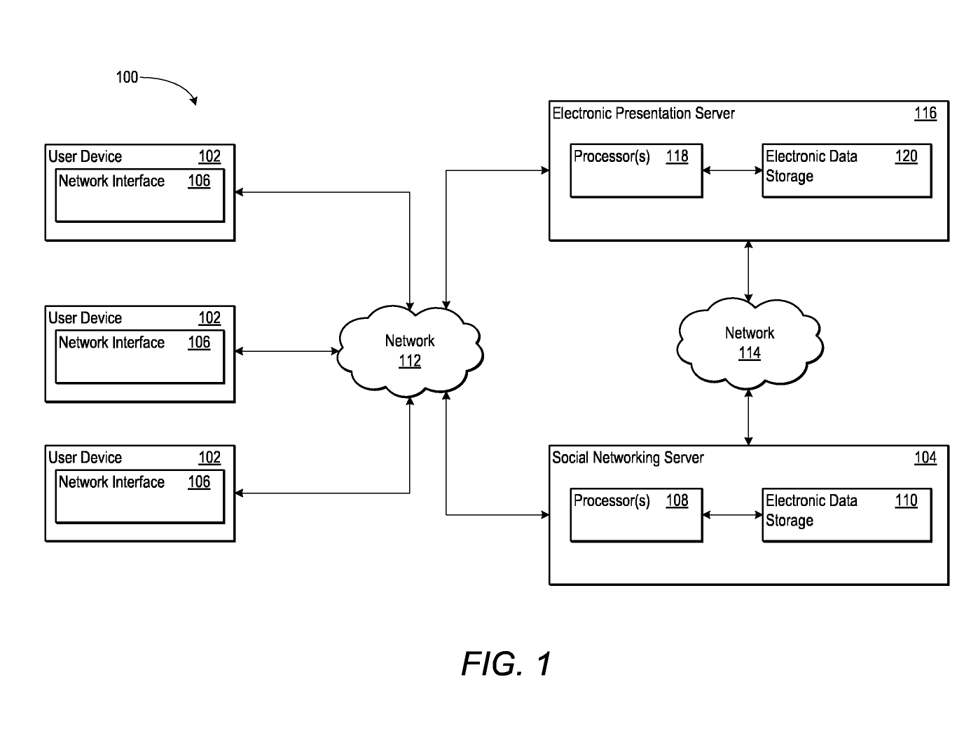

FIG. 1 is a block diagram of a system 100, in accordance with an example embodiment, for determining whether electronic presentations contain spam. In one embodiment, the system 100 includes user devices 102, a social networking server 104, and an electronic presentation server 116. The particular type of social networking server may be referred to as a business network server. User devices 102 may be a personal computer, netbook, electronic notebook, smartphone, or any electronic device known in the art that is configured to display web pages. The user devices 102 may include a network interface 106 that is communicatively coupled to a wide area network (“WAN”) 112, such as the Internet.

The social networking server 104 may be communicatively coupled to the network 112. The server 104 may be an individual server or a cluster of servers, and may be configured to perform activities related to serving the social network, such as storing social network information, processing social network information according to scripts and software applications, transmitting information to present social network information to users of the social network, and receive information from users of the social network. The server 104 may include one or more electronic data storage devices 110, such as a hard drive, optical drive, magnetic tape drive, or other such non-transitory, computer-readable media, and may further include one or more processors 108.

The one or more processors 108 may be any type of commercially available processors, such as processors available from the Intel Corporation, Advanced Micro Devices, Texas Instruments, or other such processors. Furthermore, the one or more processors 108 may be of any combination of processors, such as processors arranged to perform distributed computing via the social networking server 104.

The social networking server 104 may store information in the electronic data storage device 110 related to users and/or members of the social network, such as in the form of user characteristics corresponding to individual users of the social network. For instance, for an individual user, the user's characteristics may include one or more profile data points, including, for instance, name, age, gender, profession, prior work history or experience, educational achievement, location, citizenship status, leisure activities, likes and dislikes, and so forth. The user's characteristics may further include behavior or activities within and without the social network, as well as the user's social graph. In addition, a user and/or member may identify an association with an organization (e.g., a corporation, government entity, non-profit organization, etc.), and the social networking server 104 may be configured to group the user profile and/or member profile according to the associated organization.

For an organization, information about the organization may include name, offered products for sale, available job postings, organizational interests, forthcoming activities, and the like. For a particular available job posting, the job posting can include a job profile that includes one or more job characteristics, such as, for instance, area of expertise, prior experience, pay grade, residency or immigration status, and the like.

The electronic presentation server 116 may be communicatively coupled to the network 112. The electronic presentation server 116 may be an individual server or a cluster of servers, and may be configured to perform activities related to serving one or more electronic presentations to the user devices 102, such as storing electronic presentations, processing the electronic presentations according to scripts and software applications, transmitting information to present the electronic presentations to users of the electronic presentation server 116, and receive electronic presentations from users via the user devices 102. The presentation server 116 may include one or more electronic data storage devices 120, such as a hard drive, optical drive, magnetic tape drive, or other such non-transitory, computer-readable media, and may further include one or more processors 108.

The one or more processors 118 may be any type of commercially available processors, such as processors available from the Intel Corporation, Advanced Micro Devices, Texas Instruments, or other such processors. Furthermore, the one or more processors 118 may be of any combination of processors, such as processors arranged to perform distributed computing via the electronic presentation server 116.

The electronic presentation server 116 may store information in the electronic data storage device 120 related to users of the electronic presentation server 116 and information related to the electronic presentations. Information about electronic presentations may include the content of the electronic presentations, metadata and/or other topical information describing the content of the electronic presentations, the manner in which to display an electronic presentation, and other such information. Information related to the users of the electronic presentation server 116 may include behavioral information, such as the number of times a user has selected a given electronic presentation, the amount of time the user viewed an electronic presentation, the amount of the electronic presentation the user viewed, the types of electronic presentations the user has viewed, and other such behavioral information.

Furthermore, the electronic presentation server 116 may be communicatively coupled to the social networking server 104 via a network 114, which may be a Local Area Network (“LAN”), WAN, or combinations of LANs and WANs. By being communicatively coupled to the social networking server 104, a user may access the electronic presentation server 116 with a profile stored by the social networking server 104. Furthermore, a user having a member profile with the social networking server 104 may provide an electronic presentation to the electronic presentation server 116, and then may provide a Uniform Resource Location (“URL”) to the provided electronic presentation via the user's member profile. Thus, an external user viewing the member profile may view profile information about the user and may have access to the electronic presentation.

In addition, the electronic presentation server 116 may operate in conjunction with the social networking server 104 to determine whether any of the electronic presentations contain spam. As discussed below, the electronic presentation server 116 may communicate one or more types of information to the social networking server 104 and, in turn, may receive spam determinations from the social networking server 104.

To support these other and functionalities, the electronic presentation server 116 and the social networking server 104 may include a messaging engine to send and receive messages from one another. In one instance, the electronic presentation server 116 may be a producer of messages and the social networking server 104 may be a consumer of those messages. In another instance, the social networking server 104 may be a producer of messages and the electronic presentation server 116 may be a consumer of such messages.

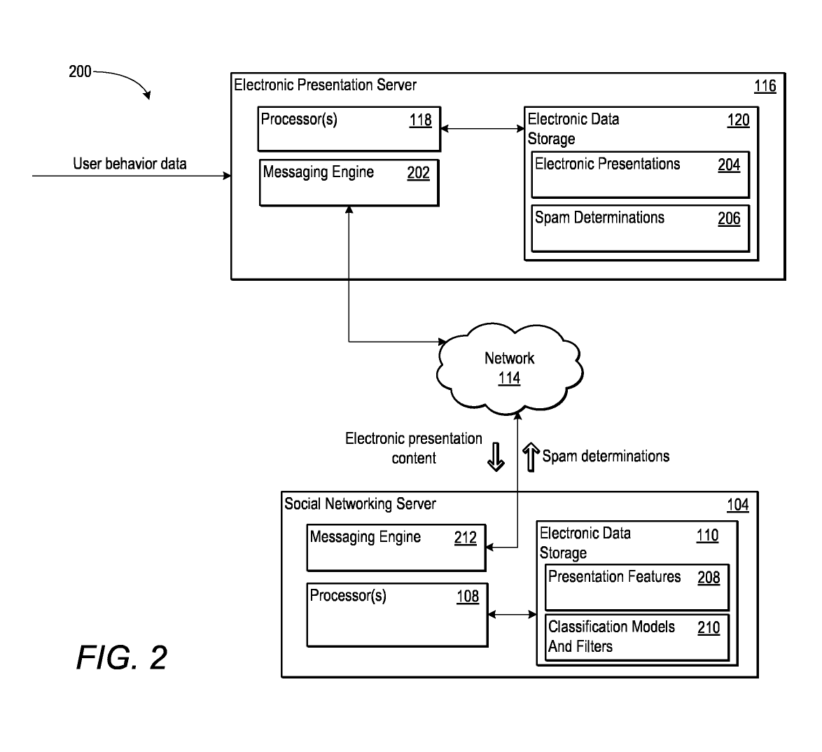

FIG. 2 is a block diagram illustrating an arrangement 200, in accordance with an example embodiment, of the of the electronic presentation server 116 and the social networking server 104 configured to exchange messages. In one embodiment, the electronic presentation server 116 may include a messaging engine 202 configured to send and receive messages to and from the social networking server 104. Similarly, the social networking server 104 may include a messaging engine 212 configured to send and receive messages to and from the electronic presentation server 116. Although shown as being housed within the electronic presentation server 116 and the social networking server 104, the messaging 202 and/or the messaging engine 212 may be housed within a differently physical structure or be distributed across multiple servers and/or computers. In one embodiment, the messaging engine 202 and/or messaging engine 212 may be Apache Kafka, which is available from the Apache Software Foundation.

In one embodiment, the electronic presentation server 116 communicates content from one or more electronic presentations 204 stored in the electronic data storage 120 to the social networking server 104 via the messaging engine 202. The content may include identifying information that identifies the electronic presentation from which it was extracted. The content may also including identifying information that indicates the particular slide from which the content was extracted.

The data communicated from the electronic presentation server 116 to the social networking server 104 may occur based on various conditions. For example, the electronic presentation server 116 may communicate the electronic presentation content at predetermined time intervals (e.g., weekly, daily, monthly, etc.). In another example, the electronic presentation 116 may communicate with the social networking server 104 when a user and/or member of the social networking server 104 access the electronic presentation server 116 (e.g., provides login credentials to the electronic presentation server 116).

When the social networking server 104 receives the presentation content and, the social networking server 104 may determine whether one or more electronic presentations contain spam based on the presentation content and, if so, how the electronic presentation server 116 should treat the corresponding electronic presentation. For example, the social networking server 104 may instruct the electronic presentation server 116 that the electronic presentation server 116 should exclude the electronic presentation containing spam from being searchable (e.g., not to be indexed by the electronic presentation server 116 so that the electronic presentation containing spam is not found during a search). Alternatively, or in addition, the electronic presentation containing spam may still be accessible, but not searchable. In another example, the social networking server 104 may instruct the electronic presentation server 116 that the electronic presentation containing spam should be removed from the electronic presentations 204. Further still, the social networking server 104 may provide a spam score to the electronic presentation server 116 indicate a level of spam that the electronic presentation contains, and the electronic presentation server may be configured to take an action (e.g., exclude from searches, removed from the electronic presentations 204, etc.) based on the spam score.

In one embodiment, the social networking server 104 may extract presentation features 208 from the presentation content and store it in the electronic data storage 110. The social networking server 104 may determine the amount of spam for a given electronic presentation based on the extracted features. Once determined, the social networking server 104 may then communicate one or more spam determinations 206 to the electronic presentation server 116 via the messaging engine 212. The electronic presentation server 116 may then store the spam determinations 206 in the electronic data storage 120.

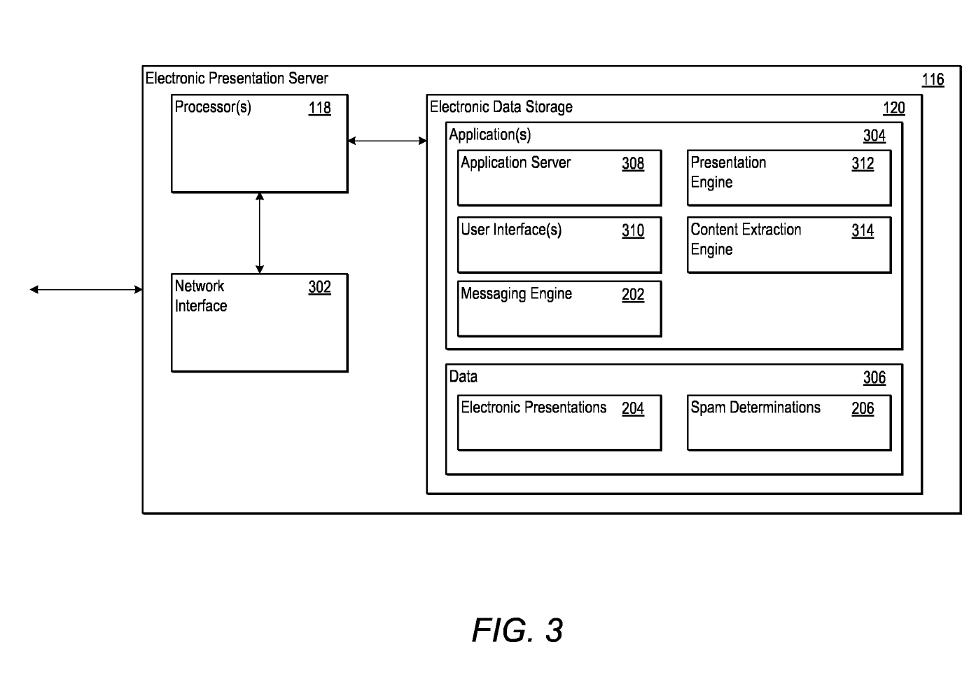

FIG. 3 illustrates the electronic presentation server 116 shown in FIG. 1 in accordance with an example embodiment. In one embodiment, the electronic presentation server 116 may include one or more processor(s) 118, one or more network interface(s) 302, one or more application(s) 304, and data 306 used by the one or more application(s) 304 stored in the electronic data storage 120.

As is understood by skilled artisans in the relevant computer and Internet-related arts, the various applications and/or engines shown in FIG. 3 may represent a set of executable software instructions and the corresponding hardware (e.g., memory and processor) for executing the instructions. To avoid obscuring the subject matter with unnecessary detail, various applications that are not germane to conveying an understanding of the inventive subject matter have been omitted from FIG. 3. However, a skilled artisan will readily recognize that various additional applications, engines, modules, etc., may be used with the electronic presentation server 116 such as that illustrated in FIG. 3, to facilitate additional functionality that is not specifically described herein. Furthermore, the various applications depicted in FIG. 3 may reside on a single server computer, or may be distributed across several server computers in various arrangements.

The electronic presentation server 116 may also include data 306, which may include one or more databases or other data stores that support the functionalities of the applications 304. In particular, data 306 may include electronic presentations 204 and the spam determinations 206. While shown as being housed in the same box as application(s) 304, it should be understood that data 306 may be housed in another location or across locations (e.g., in a distributed computing environment).

The front end of the electronic presentation server 116 may be provided by one or more user interface application(s) 310, which may receive requests from various client computing devices, and may communicate appropriate responses to the requesting client devices. For example, the user interface application(s) 310 may receive requests in the form of Hypertext Transport Protocol (HTTP) requests, or other web-based, application programming interface (API) requests. An application server 308 working in conjunction with the one or more user interface application(s) 310 may generate various user interfaces (e.g., web pages) with data retrieved from various data sources stored in the data 306. In some embodiments, individual application(s) (e.g., applications 202,308-314) may be used to implement the functionality associated with various services and features of the system 100. For instance, displaying an electronic presentation or displaying recommendations for an electronic presentation may be handled by a presentation engine 312. As another example, extracting content from an electronic presentation, such as graphics, sounds, texts, and other such content, may be handled by a content extraction engine 314.

In one embodiment, the content extraction engine 314 may extract content from an electronic presentation, such as content from the title, description, transcript, authorship, one or more tags used to classify the electronic presentation, comments regarding the electronic presentation, and other such content. The content extraction engine 314 may employ one or more classifiers that classify the extracted content.

The electronic presentation server 116 may communicate one or more items of information to the social networking server 104 via the messaging engine 202. Examples of such items of information include, but are not limited to, the content extracted from one or more electronic presentations, user profile data, the electronic presentations 204 (or identifiers thereof), and other such data.

In one embodiment, the electronic presentation server 116 extracts authorship information from the one or more electronic presentations to be used in determining whether an electronic presentation contains spam. Where the authorship indicates that a particular electronic presentation is by an author known to provide electronic presentations containing spam, the authorship information may increase the likelihood that a given electronic presentation is identified as containing spam. In addition, where a given electronic presentation is authored is by an author that is within a viewer's social network, the degree of closeness of the author within the viewer's social network may affect the likelihood that a given electronic presentation is identified as spam (e.g., as the author is connected with a user, the presumption may be that a user does not have connections who generate spam). For example, a first electronic presentation by an author that is directly connected to a viewer (e.g., is a viewer's co-worker) may have an increased likelihood of being permissible even if it is identified as containing spam-like content than a second electronic presentation by another author that is connected to the viewer's co-worker (e.g., has a 2nd-degree relationship with the viewer).

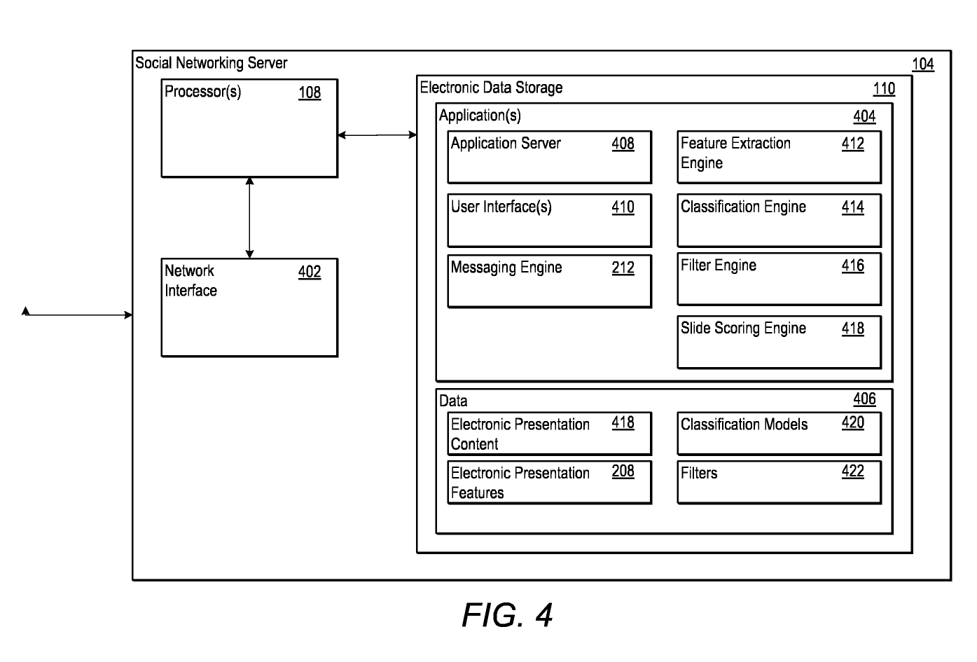

FIG. 4 illustrates the social networking server 104 in accordance with an example embodiment. In one embodiment, the social networking server 104 may include one or more processor(s) 108, one or more network interface(s) 402, one or more application(s) 404, and data 406 used by the one or more application(s) 404 stored in the electronic data storage 110.

As is understood by skilled artisans in the relevant computer and Internet-related arts, the various applications and/or engines shown in FIG. 4 may represent a set of executable software instructions and the corresponding hardware (e.g., memory and processor) for executing the instructions. To avoid obscuring the subject matter with unnecessary detail, various applications that are not germane to conveying an understanding of the inventive subject matter have been omitted from FIG. 4. However, a skilled artisan will readily recognize that various additional applications, engines, modules, etc., may be used with the social networking server 104, such as that illustrated in FIG. 4, to facilitate additional functionality that is not specifically described herein. Furthermore, the various applications depicted in FIG. 4 may reside on a single server computer, or may be distributed across several server computers in various arrangements.

The social networking server 104 may also include data 406, which may include one or more databases or other data stores that support the functionalities of the applications 404. In particular, data 406 may include user profile data, electronic presentation content 418 sent from the electronic presentation server 116, the electronic presentation features 208 extracted from the electronic presentation content 418, classification models 420 for assigning a classification to a given electronic presentation content based on its extracted features, and one or more filters 422 used in identifying whether the extracted content contains words, phrases, and/or alphanumeric characters that could be characterized as spam. After the social networking server 104 has formulated spam determinations based on the classification models 420 and/or the filters 422, the social networking server 104 may communicate the spam determinations to the electronic presentation server 116 via the messaging engine 212.

The front end of the electronic presentation server 104 may be provided by one or more user interface application(s) 410, which may receive requests from various client computing devices, and may communicate appropriate responses to the requesting client devices. For example, the user interface application(s) 410 may receive requests in the form of Hypertext Transport Protocol (HTTP) requests, or other web-based, application programming interface (API) requests. An application server 408 working in conjunction with the one or more user interface application(s) 410 may generate various user interfaces (e.g., web pages) with data retrieved from various data sources stored in the data 406. In some embodiments, individual application(s) (e.g., applications 212,408-416) may be used to implement the functionality associated with various services and features of the system 100. For instance, extracting one or more features from the electronic presentation content may be handled by a feature extraction engine 412.

In one embodiment, the feature extraction engine 412 determines the electronic presentation features 208 from the electronic presentation content 418 by classifying and identifying the electronic presentation content 418. Examples of the determined electronic presentation features 208 include extracted tokens from the electronic presentation content 418 (e.g., via a tokenizer), a detected language of the electronic presentation (e.g., English, Spanish, Japanese, German, etc.), one or more named entities (e.g., proper nouns, names, specific locations, etc.), one or more topics associated with the electronic presentation, one or more skills associated with a given electronic presentation, one or more n-grams, various style features (e.g., font, typeface, background, colors, use of bullets, animations), and the quality of a given electronic presentation. Quality for a given electronic presentation may be denoted on a sliding scale, where quality may correlate to how each slide of an electronic presentation is structured, such as a ratio of graphics and text, where there is a company name used in the slide and/or electronic presentation (e.g., how well known the company is), a hyperlink to the presentation author's website or user profile, whether the electronic presentation has been viewed over a given threshold (e.g., a viewing threshold), whether one or more users has indicated a preference for the electronic presentation (e.g., has “liked” the electronic presentation), and other such features.

Based on the determined features, the social networking server 104 may determine one or more classifications for a given electronic presentation. Further still, the classifications may be made on a per slide basis, such that each slide of the electronic presentation is assigned a classification. To that end, the social networking server 104 may include a classification engine 414 and one or more classification models 420. The classification engine 414 may be a maximum entropy classifier, where each of the classification models 420 are used by the classification engine 414 to determine a classification for a given slide of an electronic presentation. The classification models 420 may include a job posting model, which is used to determine whether the slide is directed to a job posting, a promotion model, which is used to determine whether the slide is directed to a promotion (e.g., an advertisement), and an event classification model, which is used to determine whether a given slide is a directed to an event or activity. Other classification models or variations on the foregoing classification models may also be used.

Using the classification engine 414, the social networking server 104 may assign a classification to a given slide of an electronic presentation. The classification assigned to the slide may affect a spam score assigned to the slide. For example, where the slide is assigned one or more of the classifications defined by the classification models 420, the spam score assigned to the slide may be increased. Alternatively, the slide may not be assigned a classification, in which case, the slide may not be associated with a spam score or have a null spam score.

Further still, each of the filters classification models 420 may be associated with a different value that affects the spam score. For example, the job posting classification model may be assigned with a higher value (e.g., 1, 2, 4, etc.) than the event classification model (e.g., 0.2, 0.4, 0.6, etc.) Moreover, the value of the assigned classification may be applied differently. For example, the value associated with the job posting classification model may be a multiplier, whereas the value associated with the event classification model may be an additive. In this way, different classification models may affect the spam score assigned to a given slide differently. However, as discussed below with reference to the filter engine 416, the slide of the electronic presentation may still be assigned a spam score even if it is not assigned a classification.

The social networking server 104 may also invoke a filter engine 416 to determine whether a given slide contains words or phrases associated with spam. To that end, the social networking server 104 may include one or more filters 422, which may be used to determine whether a given slide contains the spam or spam-like words and/or phrases. The filter engine 416 may apply one or more of the filters 422 on the extracted content 418, the determined features 208, or combinations thereof.

The filters 422 may be implemented as regular expressions, and the filters 422 may include a regular expression that searches for a particular words and/or phrases (e.g., “buy now,” “work from home,” etc.), a regular expression that searches for a Uniform Resource Location (“URL”), a regular expression that searches for an e-mail address, a regular expression that searches for a phone number, and other such filters or combination of filters.

The filter engine 416 may be configured such that a predetermined set of filters 422 are applied based on the classification assigned to a given slide. Thus, each classification may be assigned with a specific set of filters. For example, where a slide is assigned a “job posting” classification, the filter engine 416 may apply the words and phrases filter and the URL filter. As another example, where a slide is assigned an “event” classification, the filter engine 416 may apply the phone number filter and the URL filter. Alternatively, or in addition, the filter engine 416 may apply the filters 422 regardless of the classification assigned to a given slide or even if there is no classification assigned to a given slide.

Where the filter engine 416 determines that the content and/or features of a given slide satisfy a given filter, the spam score assigned to the given slide may be affected. For example, the spam score assigned to a given slide may increase whenever the slide is determined to satisfy a given filter. Further still, each of the filters 422 may be associated with a different value that affects the spam score. For example, the words and phrases filter may be assigned with a higher value (e.g., 1, 2, 4, etc.) than the URL filter (e.g., 0.2, 0.4, 0.6, etc.) Moreover, the value of the applied filter may be applied differently. For example, the value associated with the words and phrases filter may be a multiplier, whereas the value associated with the URL filter may be an additive. In this way, different filters may affect the spam score assigned to a given slide differently.

The social networking server 104 may further include a slide scoring engine 418 that assigns a spam score to a given slide. The spam score may be based on a variety of factors, such as the spam value of the one or more classifications assigned to the slide, whether the slide satisfied one or more of the filters 422, the authorship of the slide, the relative position of the slide within the electronic presentation, whether the slide is a duplicate, and other such factors or combination of factors.

With regard to authorship, where the slide is by an author that is known to have other spam or spam-like electronic presentations, the slide scoring engine 418 may assign a higher score to the slide. In contrast, where the slide is by an author that appears as a connection for user viewing the slide, the spam score may be decreased by a predetermined amount (e.g., a percentage, a numerical value, etc.) As to the relative position of the slide, the spam score assigned to the slide may increase or decrease depending on where the slide occurs within the electronic presentation. For example, where the slide occurs as the first or last slide, the slide scoring engine 418 may decrease the spam score by a predetermined amount. Alternatively, where the slide occurs towards the middle of the electronic presentation, the slide scoring engine 418 may increase or keep the spam score assigned to the slide unchanged. Further still, positions within an electronic presentation may be assigned a spectrum of values (e.g., starting at 0, increasing towards the middle, decreasing after the middle, ending at 0), and the spam score assigned to the slide may be affected based on this spectrum. Where the slide is determined as being a duplicate (e.g., the features in a first slide are identical, or nearly identical, to the features of a second slide), the spam score assigned to the slide may be increased, since it is likely that the author is trying to increase the number of views of the spam content by having duplicate slides. In this manner, the slide scoring engine 418 is a flexible mechanism that assigns or adjusts spam scores of slides for an electronic presentation based on one or more factors.

Having determined individual slide scores, the slide scoring engine 418 may determine an overall spam score for a given electronic presentation based on the scores assigned to the individual slides that make up the electronic presentation. The social networking server 104 may then provide this overall score to the electronic presentation server 116 for taking an action with respect to the given electronic presentation, such as by omitting the electronic presentation from an indexing service or by removing the electronic presentation entirely. Alternatively, or in addition, the social networking server 104 may also provide individual slide spam scores to the electronic presentation server 116 so that the electronic presentation server 116 can act on a given slide. For example, the electronic presentation server 116 may modify an electronic presentation having a slide with a high spam score (e.g., at or over a spam score threshold) by deleting or removing the slide with the high spam score from the electronic presentation. Further still, an electronic presentation may be flagged for moderation, such that a moderator reviews the electronic presentation and/or the slide from the electronic presentation to determine whether the electronic presentation and/or slide should be viewable and/or searchable to users of the electronic presentation server 116.

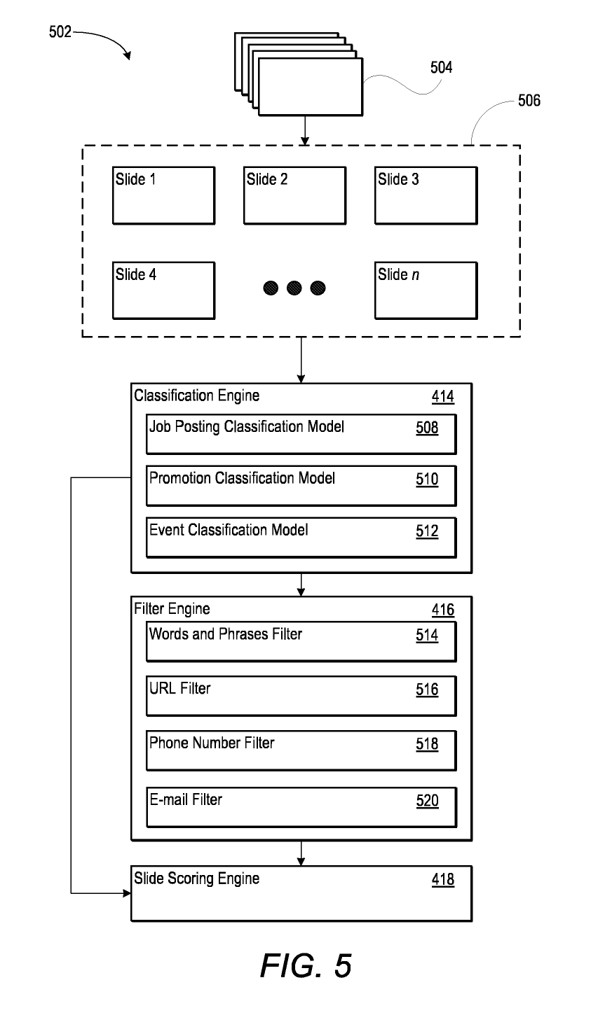

FIG. 5 illustrates an example method 502, according to an example embodiment, for classifying and applying a filter to individual slides 506 of an electronic presentation 504. Initially, the electronic presentation 504 may be decomposed into individual slides 506. The contents of the individual slides 506 may be extracted, and features for the extracted contents may be determined. The content and/or features are then provided to the classification engine 414. The classification engine 414 may then apply one or more classification models 508-512 to the extracted content and/or determined features. The resulting classification (or classifications) assigned to the extracted content and/or determined features may be associated with a spam value.

The extracted content and/or determined features may then be passed to the filter engine 416, which may apply one or more filters 514-520 to the extracted content and/or determined features. As with the classification engine 414, the application of the filters 514-520 may result in one or more spam values being associated with the extracted content and/or determined features. For example, where each of the filters 514-520 are satisfied, the extracted content and/or determined features would be assigned four spam values.

The spam values from the classification engine 414 and the filter engine 416 may then be passed to the slide scoring engine 418. The slide scoring engine 418 may then determine a spam score for a given slide based on the provided spam values. As discussed previously, the spam score for a given slide may be further affected by other factors, such as the author of the slide (or electronic presentation), or where the slide appears in the electronic presentation relative to other slides.

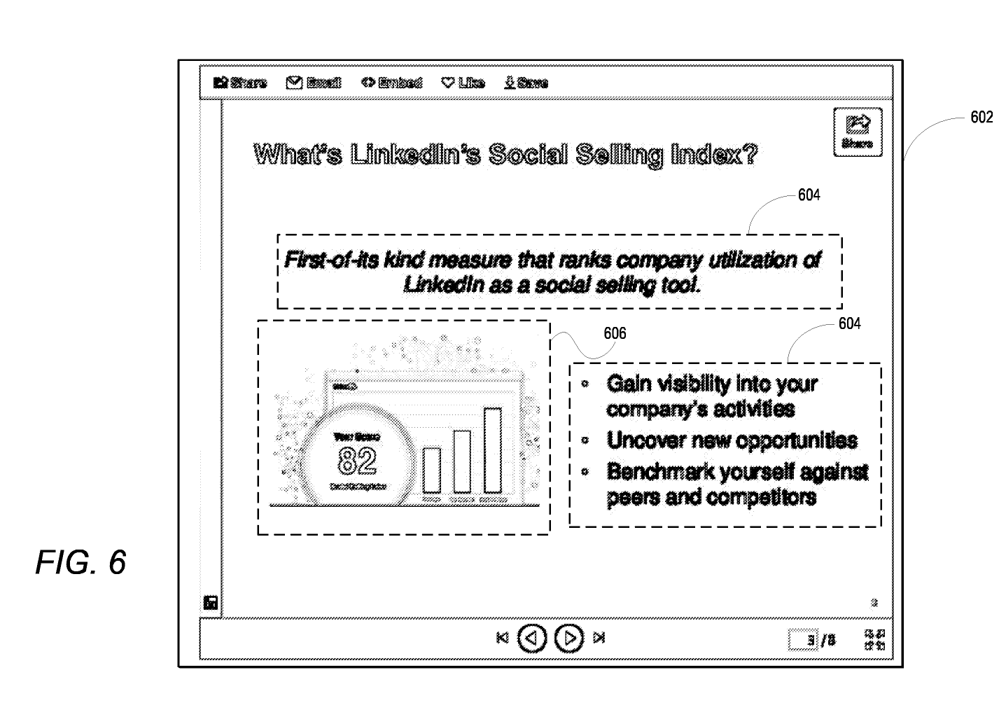

FIG. 6 illustrates a graphical user interface, in accordance with an example embodiment, displaying an electronic presentation 602 hosted by the electronic presentation server 116. In one embodiment, the electronic presentation 602 may include multiple types of content, such as graphical content 606 and textual content 604. The electronic presentation 602 may also include other types of content, such as sounds, movies, or other audiovisual content. Referring to FIGS. 3-4, the content extraction engine 314 may be configured to extract the graphical content 606 and the textual content 604 from the electronic presentation 602. For example, the content extraction engine 314 may perform optical character recognition on the textual content 604 and image recognition on the graphical content 606. Once the content 604,606 has been extracted from the electronic presentation 602, the feature extraction engine 412 may then extract the features from the textual content 604 and graphical content 606.

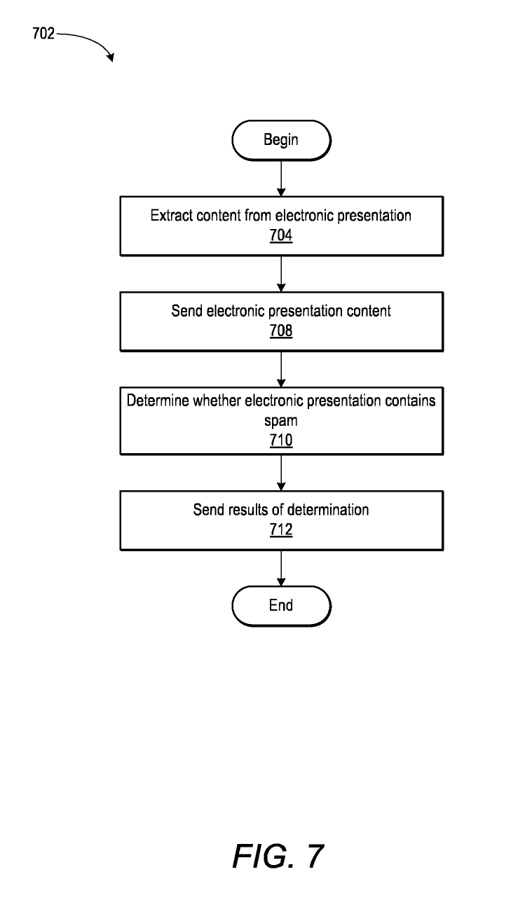

FIG. 7 illustrates a method 702, according to an example embodiment, for determining whether an electronic presentation contains spam. The method 702 may be implemented by the electronic presentation server 116 and the social networking server 104 and, accordingly, is merely described by way of reference thereto. The method 702 may include extracting content from an electronic presentation (Operation 704). The extracted content may be associated with one or more slides. The extracted content may then be sent to the social networking server 104 (Operation 708). The social networking server 104 may then determine whether the electronic presentation contains spam based on the extracted content (Operation 710). The social networking server 104 may then send the results of its determinations to the electronic presentation server 116 (Operation 712). Initially, the electronic presentation server 116 may receive one or more electronic presentations 204 (Operation 704). For example, the electronic presentation server 116 may receive the one or more electronic presentations 204 from one or more user devices 102.

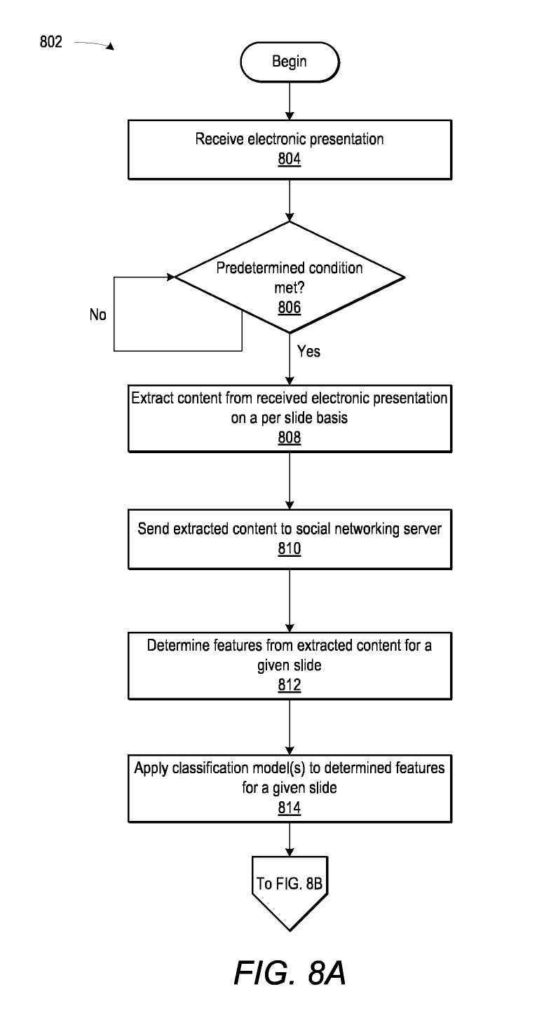

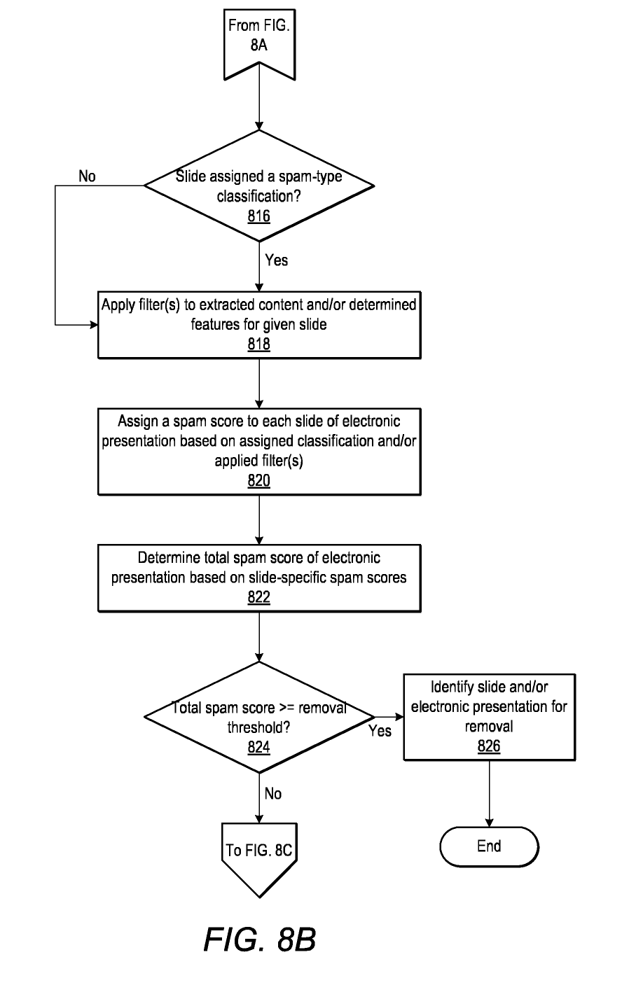

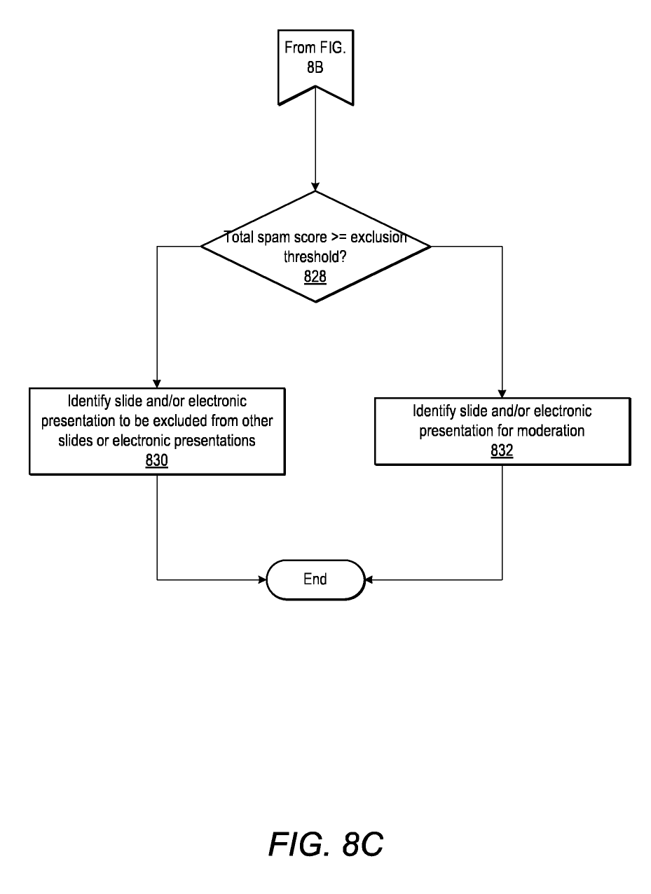

FIGS. 8A-8C illustrate a method 802, in accordance with an example embodiment, for determining recommendations of electronic presentations. The method 802 may be implemented by the electronic presentation server 116 and the social networking server 104 and, accordingly, is merely described by way of reference thereto. Initially, the electronic presentation server 116 may receive one or more electronic presentations 204 (Operation 804). For example, the electronic presentation server 116 may receive the one or more electronic presentations 204 from one or more user devices 102.

The electronic presentation server 116 may then determine whether one or more conditions have been met (Operation 806). As discussed above, the condition may be the expiration of a predetermined time interval, a user logging in or accessing the electronic presentation server 116, or a combination of conditions.

The electronic presentation server 116 may then extract content from one or more of the electronic presentations (Operation 808). As discussed above, the extracted content may include graphical content extracted using one or more image recognition techniques, textual content extracting using one or more optical character recognition techniques, audio content, and other types of content.

The extracted content may then be communicated to the social networking server 104 (Operation 810). Using one or more engines, such as the feature extraction engine 412, the social networking server 104 may determine one or more features from the extracted content (Operation 812). As discussed above, the features may include tokens from the electronic presentation content (e.g., via a tokenizer), a detected language of the electronic presentation (e.g., English, Spanish, Japanese, German, etc.), one or more named entities (e.g., proper nouns, names, specific locations, etc.), one or more topics associated with the electronic presentation, one or more skills associated with a given electronic presentation, one or more n-grams, various style features (e.g., font, typeface, background, colors, use of bullets, animations), and the quality of a given electronic presentation.

Having determined one or more features from the extracted content, the social networking server 104 may then determine one or more classifications for a given slide based on the determined features or extracted content (Operation 814). A spam value may be assigned to the determined features (collectively or individually) and/or the extracted content (collectively or individually) based on the classification(s) assigned to the determined features and/or extracted content.

A determination may then be made as to the classifications assigned to the extracted content and/or determined features (Operation 816). For example, different filters may be applied to the extracted content and/or determined features depending on the classification assigned to the extracted content and/or determined features (Operation 818). In another example, all of the filters may be applied to the extracted content and/or determined features regardless of the assigned classifications (Operation 818). In yet a further example, the filters are not applied to the extracted content and/or determined features when it is determined that the extracted content and/or the determined features have not been assigned a spam classification. A spam score may then be applied to a given slide based on the assigned classification and the applied filters (Operation 820). Similarly, a spam score may be determined for the electronic presentation based on the spam scores assigned to each of its component slides (Operation 822). Where the spam score of the electronic presentation is above a removal threshold (Operation 824), the electronic presentation may be identified for removal from the electronic presentation server 116 (Operation 826). Alternatively, or in addition, individual slides of the electronic presentation may be identified for removal based on the same, or different, removal threshold.

A determination may then be made as to whether the spam score for a given slide and/or electronic presentation is above a predetermined exclusion threshold (Operation 828). Where the score assigned to the slide and/or electronic presentation is above the exclusion threshold, the slide and/or the electronic presentation may be identified for exclusion from other slides (e.g., of the same electronic presentation) or from other electronic presentations (e.g., of the collection of electronic presentations) (Operation 830). Alternatively, where the score assigned to the slide and/or electronic presentation is below the exclusion threshold, the slide and/or electronic presentation may be flagged for moderation by a moderator (Operation 832). The slide and/or electronic presentation may require moderation because it is possible that the slide and/or electronic presentation has been identified as containing spam, but that the potential spam is relevant to the contents of the slide and/or electronic presentation.

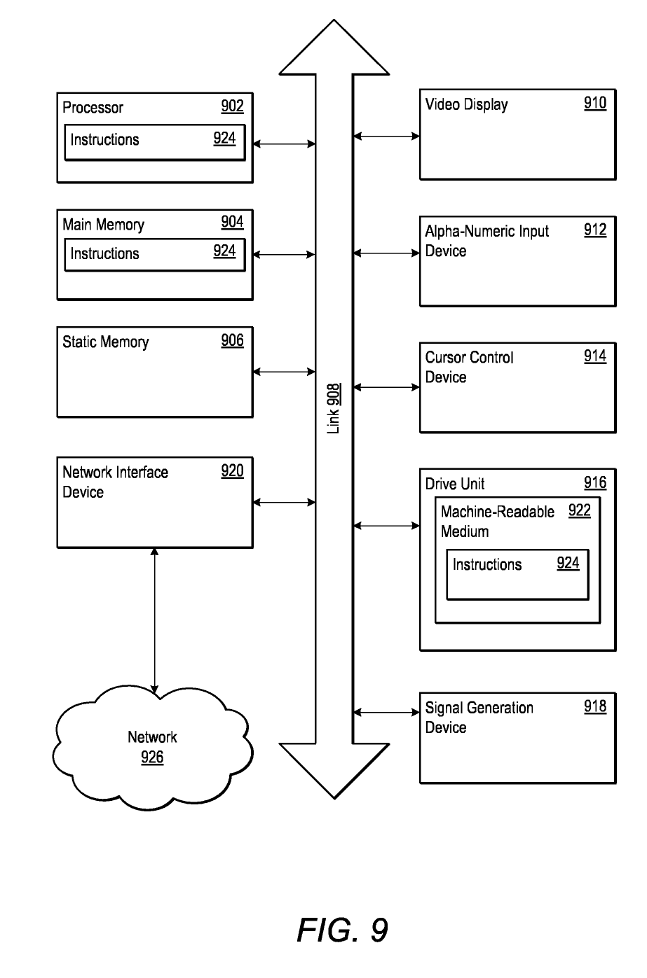

FIG. 9 is a block diagram illustrating components of a machine 900, in accordance with an example embodiment, configured to read instructions from a machine-readable medium (e.g., a machine-readable storage medium) and perform any one or more of the methodologies discussed herein. Specifically, FIG. 9 shows a diagrammatic representation of the machine 900 in the example form of a computer system and within which instructions 924 (e.g., software) for causing the machine 900 to perform any one or more of the methodologies discussed herein may be executed. In alternative examples, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The machine 900 may further include a graphics display 910 (e.g., a plasma display panel (PDP), a light emitting diode (LED) display, a liquid crystal display (LCD), a projector, or a cathode ray tube (CRT)). The machine 900 may also include an alphanumeric input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a speaker), and a network interface device 920.

The storage unit 916 includes a machine-readable medium 922 on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, during execution thereof by the machine 900. Accordingly, the main memory 904 and the processor 902 may be considered as machine-readable media. The instructions 924 may be transmitted or received over a network 926 via the network interface device 920.

In this manner, a user visiting a web site hosted by the electronic presentation server 116 may receive recommended electronic presentations based on a given electronic presentation. With recommended electronic presentations available to the user, a user is more likely to engage the electronic presentation web site. Furthermore, the electronic presentations presented to the user are more likely to be relevant to a user and saves the user time and effort in having to find electronic presentations that may be of interest to the user.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 900), such that the instructions, when executed by one or more processors of the machine (e.g., processor 902), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A computer-implemented method comprising:
receiving an electronic presentation, the electronic presentation comprising a plurality of slides, wherein at least one slide contains content for viewing by a user;
extracting content from a slide selected from the plurality slides based on a determination that the selected slide contains content;
determining a plurality of features for each slide of the plurality of slides based on the content extracted from a corresponding slide;
assigning a classification to each slide based on the features determined for the corresponding slide, the assigned classification identifying the type of content contained within the corresponding slide;
applying a filter to each slide based on the features determined for the slide, the applied filter identifying whether the slide contains a predetermined plurality of alphanumeric characters;
determining whether each slide of the plurality of slides contains spam based on the applied filter and assigned classification to the slide;
adjusting the spam determination of each slide of the plurality of slides based on a location of a corresponding slide relative to the plurality of slides of the electronic presentation; and
determining whether the electronic presentation is spam based on the adjusted spam determination for each slide of the plurality of slides.

2. The computer-implemented method of claim 1, wherein assigning the classification to each slide is based on the application of a maximum entropy classifier to each slide.

3. The computer-implemented method of claim 1, wherein assigning the classification to each slide is based on a classification model trained for the classification.

4. The computer-implemented method of claim 1, further comprising selecting the filter from a plurality of filters to apply to each slide based on the classification assigned to the corresponding slide, wherein a first filter of the plurality of filters is associated with a first classification and a second filter of the plurality of filters is associated with a second classification.

5. The computer-implemented method of claim 1, further comprising modifying the electronic presentation based on the adjusted spam determination.

6. The computer-implemented method of claim 6, wherein modifying the electronic presentation comprises removing the electronic presentation from being discoverable by a search query applied to a plurality of electronic presentations.

7. The computer-implemented method of claim 6, wherein modifying the electronic presentation comprises removing a slide selected from a plurality of slides based on the adjusted spam determination for the selected slide.

8. The computer-implemented method of claim 1, further comprising identifying the electronic presentation for moderation based on the adjusted spam determination.

9. A system comprising:
a non-transitory, computer-readable medium storing computer-executable instructions; and
one or more processors in communication with the non-transitory, computer-readable medium that, having executed the computer-executable instructions, are configured to:
receive an electronic presentation, the electronic presentation containing a plurality of slides, wherein at least one slide contains content for viewing by a user;
for each slide of the plurality of slides, determine a plurality of features for a corresponding slide, the determined features based on content extracted from the corresponding slide;
assign at least one classification to each slide of the plurality of slides based on the features determined for the corresponding slide;
determine whether a filter is satisfied for each slide of the plurality of slides, the filter identifying whether a given slide includes a plurality of alphanumeric characters;
determine a spam value for each slide of the plurality of slides, the spam value based on the assigned classification for the corresponding slide, whether the filter was satisfied for the corresponding slide, and a location of the corresponding slide relative to the plurality of slides; and
determine an overall spam value for the electronic presentation, the overall spam value based on each spam value determined for each slide of the plurality of slides.

10. The system of claim 9, wherein the one or more processors are further configured to assign the classification to each slide based on the application of a maximum entropy classifier to each slide.

11. The system of claim 9, wherein the one or more processors are configured to assign the classification to each slide based on a classification model trained for the classification.

12. The system of claim 9, wherein the one or more processors are further configured to select the filter from a plurality of filters to apply to each slide based on the classification assigned to the corresponding slide, wherein a first filter of the plurality of filters is associated with a first classification and a second filter of the plurality of filters is associated with a second classification.

13. The system of claim 9, wherein the one or more processors are further configured to modify the electronic presentation based on the overall spam value.

14. The system of claim 13, wherein the one or more processors are configured to modify the electronic presentation by removing the electronic presentation from being discoverable by a search query applied to a plurality of electronic presentations.

15. The system of claim 13, wherein the one or more processors are configured to modify the electronic presentation by removing a slide selected from a plurality of slides based on the adjusted spam determination for the selected slide.

16. The system of claim 9, wherein the one or more processors are further configured to identify the electronic presentation for moderation based on the overall spam value.

17. A non-transitory, computer-readable medium storing computer-executable instructions thereon that, when executed by one or more processors, cause the one or more processors to perform a method, the method comprising:
receiving an electronic presentation, the electronic presentation comprising a plurality of slides, wherein at least one slide contains content for viewing by a user;
extracting content from a slide selected from the plurality slides based on a determination that the selected slide contains content;
determining a plurality of features for each slide of the plurality of slides based on the content extracted from a corresponding slide;
assigning a classification to each slide based on the features determined for the corresponding slide, the assigned classification identifying the type of content contained within the corresponding slide;
applying a filter to each slide based on the features determined for the slide, the applied filter identifying whether the slide contains a predetermined plurality of alphanumeric characters;
determining whether each slide of the plurality of slides contains spam based on the applied filter and assigned classification to the slide;
adjusting the spam determination of each slide of the plurality of slides based on a location of a corresponding slide relative to the plurality of slides of the electronic presentation; and
determining whether the electronic presentation is spam based on the adjusted spam determination for each slide of the plurality of slides.

18. The non-transitory, computer-readable medium of claim 17, wherein assigning the classification to each slide is based on the application of a maximum entropy classifier to each slide.

19. The non-transitory, computer-readable medium of claim 17, wherein the method further comprises modifying the electronic presentation based on the adjusted spam determination.

20. The non-transitory, computer-readable medium of claim 19, wherein modifying the electronic presentation comprises removing the electronic presentation from being discoverable by a search query applied to a plurality of electronic presentations.
